(19) United States
(12) Patent Application Publication
(10) Pub. No.: US 2016/0046855 A1
(43) Pub. Date: Feb. 18, 2016

(54) Asphaltene Inhibition

(71) Applicant: The Lubrizol Corporation, Wickliffe, OH (US)

(72) Inventors: Antonio Mastrangelo, Alfreton (GB); Hannah Greenfield, Derby (GB); John W. Dunkerley, Belper (GB)

(21) Appl. No.: 14/777,773

(22) PCT Filed: May 20, 2014
(86) PCT No.: PCT/US2014/038705

§ 371 Date: Sep. 17, 2015

Related U.S. Application Data
(60) Provisional application No. 61/827,781, filed on May 28, 2013.

(51) Int. Cl. C09K 8/524

(52) U.S. Cl. CPC C09K 8/524

(57) ABSTRACT

The technology disclosed herein provides compositions and methods for asphaltene control in a hydrocarbon fluid, such as crude oil, by employing a quaternary ammonium salt.

### BACKGROUND OF THE INVENTION

The technology disclosed herein provides a composition and method for asphaltene control in a hydrocarbon fluid, such as crude oil, by employing a quaternary ammonium salt.

It is well known that hydrocarbon fluids, such as crude oil or residual oil, deposit asphaltenes during production and/or use. In the example of a crude oil, asphaltenes are maintained in a stable colloidal dispersion in the hydrocarbon fluid under the temperature, pressure, composition and environmental conditions found in the oil bearing reservoir. However, when the temperature or pressure are reduced e.g. during extraction from an oil reservoir, changes in composition (loss of gas and other light components) largely due to pressure and temperature changes enables asphaltene molecules to agglomerate or otherwise precipitate out to form asphaltene deposits. The asphaltene deposits are capable of causing occlusion and ultimately blockage within the oil bearing strata or anywhere else along the production and storage system through which the oil passes or is stored, including any pipe, conduit or storage vessel. The occlusion reduces production rates such that it becomes necessary to mechanically remove the deposits, resulting in loss of production, down-time and increased engineering costs.

In the case of asphaltenic residual and heavy fuels, the destabilization of the asphaltene colloid is generally due to similar reasons, but also due to the addition of cutter stocks or in-tank mixing of different and incompatible batches of fuel, which can result in a hydrocarbon environment which does not maintain the stability of the asphaltenes. An example of this often seen in practice is when ships change over to low sulphur fuel for entry into areas where the use of high sulphur fuels is prohibited. Changing over to low sulphur fuel can destabilize the asphaltene resulting in asphaltene deposition in pipework and possible blockage of filters, etc. Therefore it is important to efficiently disperse agglomerated asphaltenes in the bulk hydrocarbon, or to remove and/or inhibit the formation of asphaltene deposits to avoid blockage in a crude oil production system.

In the case of asphaltene deposition in refinery and other petrochemical plant applications, a hydrocarbon stream already containing asphaltenes can be formed in situ. In this case, the asphaltene deposition results in the formation of carbonaceous deposits in a process known as coking or fouling.

Therefore asphaltene deposits are known to be capable of causing blockage to a number of applications involving a hydrocarbon fluid and it is important to remove or inhibit the formation of asphaltene deposits to avoid blockage of an oil well or pipelines.

British Patent application GB 2,337,522 discloses a carboxylic polymer capable of reducing asphaltene deposition formed from at least one of (a) an ethylenically unsaturated alcohol, carboxylic acid or ester, (b) an ethylenically unsaturated carboxylic ester with a polar group in the ester, and (c) an ethylenically unsaturated carboxylic amide. A preferred polymer is a alkyl (meth) acrylate.

International Publication WO 01/055281 discloses an inhibitor for asphaltene deposition employing a compound selected from a polyhydric alcohol reacted with a carboxylic acid, an ester or ether formed from a glycidyl ether or epoxide.

It would be desirable to have a method of asphaltene control in a hydrocarbon fluid. The present technology provides methods of asphaltene control in a hydrocarbon fluid as well as asphaltene controlled compositions.

### SUMMARY OF THE INVENTION

There is provided a method of asphaltene control in a hydrocarbon fluid, the method employing a quaternary ammonium salt.

In one embodiment, the quaternary ammonium salt can include the reaction product of: (a) the reaction product of a hydrocarbyl substituted acylating agent and a compound having an oxygen or nitrogen atom capable of condensing with said hydrocarbyl substituted acylating agent and further having a tertiary amino group; and (b) a quaternizing agent suitable for converting the tertiary amino group to a quaternary nitrogen.

In one embodiment, the hydrocarbyl substituted acylating agent can be a polyisobutylene succinic acid or anhydride. The polyisobutylene of the polyisobutylene succinic acid or anhydride can have a number average molecular weight of from between about 150 to about 5000.

In another embodiment, the hydrocarbyl substituted acylating agent can be a polyhydroxy carboxylic acid, such as, for example, polyhydroxy stearic acid.

In an embodiment, the compound having an oxygen or nitrogen atom capable of condensing with said hydrocarbyl substituted acylating agent and further having a tertiary amino group can be N,N-dimethyl-1,3-diaminopropane.

In an embodiment, the quaternizing agent used to quaternize the tertiary amino group can be a dialkyl sulfate; alkyl halides; benzyl halides; haloacetic acids/salts; hydrocarbyl substituted carbonates; hydrocarbyl substituted oxalate esters; hydrocarbyl epoxides optionally in combination with an acid; and mixtures thereof.

In a further embodiment, the method can be employed in a hydrocarbon fluid having an asphaltene content of at least 0.01 wt %, and in some embodiments, up to 90 wt % of the total weight of the hydrocarbon fluid.

Another aspect of the disclosure is directed to an asphaltene controlled composition. The composition can include (a) a hydrocarbon fluid; and (b) a quaternary ammonium salt. The quaternary ammonium salt can include (i) the reaction product of a hydrocarbyl substituted acylating agent and a compound having an oxygen or nitrogen atom capable of condensing with said hydrocarbyl substituted acylating agent and further having a tertiary amino group; and (ii) a quaternizing agent suitable for converting the tertiary amino group to a quaternary nitrogen. In come embodiments the composition can optionally additional include an oil of lubricating viscosity.

In embodiments of the method and/or the composition, the hydrocarbon fluid can be an oil field product, such as crude oil, a refinery or petrochemical process stream, a heavy distillate or residual fuel.

### DETAILED DESCRIPTION OF THE INVENTION

There is provided a method of asphaltene control in a hydrocarbon fluid, the method comprising employing a composition comprising: a hydrocarbon fluid and a quaternary ammonium salt.

### Hydrocarbon Fluid

The hydrocarbon fluid can be an oil, including aliphatic or liquid aromatic oils. The hydrocarbon fluid may be crude oil, black oil, or a non-volatile fraction from a distillation of a crude oil. The hydrocarbon fluid may also be a heavy fuel such as a heavy distillate heating oil or marine/industrial fuel oil, including bunker fuel. The hydrocarbon fluid may also be any petrochemical process oil which has a propensity to form asphaltenic and ultimately coke-like species at surfaces under high temperature conditions. In one embodiment the hydrocarbon fluid can be an oil field product, e.g. a whole well product or a multiphase mixture in or from a well bore, or one at a well head after at least partial separation of gas and/or water, for instance, an oil export fraction. In one embodiment the hydrocarbon fluid can be a refinery or petrochemical process stream or a heavy distillate or residual fuel.

The hydrocarbon may contain at least 0.01 wt % of asphaltene, in another embodiment up to 30 wt % of asphaltene based on the total weight of the hydrocarbon fluid. Examples of suitable ranges of asphaltene present in the hydrocarbon fluid include up to 90 wt % or 0.001 wt % to 90 wt %, 0.01 wt % to 70 wt % or 0.04 to 50 wt % or 0.06 to 30 wt %. In one embodiment the asphaltene content can be up to 90 wt %, based on the total weight of the hydrocarbon fluid. Generally oil shale, bitumen or asphalt hydrocarbon fluids contain higher levels of asphaltene.

The hydrocarbon fluid may further comprise wax, often present from 0 wt % to 35 wt %, 0.5 wt % to 30 wt % or 1 wt % to 15 wt %, based on the total weight of the hydrocarbon fluid; gas present from 0 wt % to 10 wt % or water (or water droplets) from 0 wt % to 20 wt %, based on the total weight of the hydrocarbon fluid. The hydrocarbon fluid in one embodiment has multiple phases between the oil and gas and/or water.

### The Quaternary Ammonium Salt

The quaternary ammonium salts can include the reaction product of: (i) a compound comprising at least one tertiary amino group; and (ii) a quaternizing agent suitable for converting the tertiary amino group of compound (i) to a quaternary nitrogen. Various embodiments of suitable quaternary ammonium salts are described herein, each of which are contemplated for use alone or in combination.

The quaternary ammonium salt may be the reaction product of: (i) at least one compound which may include: (a) the condensation product of a hydrocarbyl-substituted acylating agent and a compound having an oxygen or nitrogen atom capable of condensing the acylating agent where the condensation product has at least one tertiary amino group; (b) a polyalkene-substituted amine having at least one tertiary amino group; and (c) a Mannich reaction product having at least one tertiary amino group, where the Mannich reaction product is derived from a hydrocarbyl-substituted phenol, an aldehyde, and an amine; and (ii) a quaternizing agent suitable for converting the tertiary amino group of compound (i) to a quaternary nitrogen. The quaternizing agent may include dialkyl sulfates; alkyl halides; benzyl halides; haloacetic acids/salts; hydrocarbyl substituted carbonates; hydrocarbyl substituted oxalate esters; hydrocarbyl epoxides or hydrocarbyl epoxides in combination with an acid; and mixtures thereof.

The compounds of component (i)(a), (i)(b) and (i)(c), described in greater detail below, contain at least one tertiary amino group and include compounds that may be alkylated to contain at least one tertiary amino group after an alkylation step. In some embodiments the quaternary ammonium salt may be the reaction product of a polyalkene chloride, for example polyisobutylene chloride and a compound with a tertiary amine. In such embodiments the polyisobutylene chloride is the quaternizing agent and the compound with a tertiary amine is component (i). Suitable examples of component (i) for such embodiments includes tertiary amines such as trimethylamine.

Examples of quaternary ammonium salt and methods for preparing the same are described in U.S. Pat. Nos. 4,253,980; 3,778,371; 4,171,959; 4,326,973; 4,338,206; and 5,254,138.

The quaternary ammonium salts may be prepared in the presence of a solvent, which may or may not be removed once the reaction is complete. Suitable solvents include, but are not limited to, diluent oil, petroleum naphtha, and certain alcohols. In one embodiment, these alcohols contain at least 2 carbon atoms, and in other embodiments at least 4, at least 6 or at least 8 carbon atoms. In another embodiment, the solvent can contain 2 to 20 carbon atoms, 4 to 16 carbon atoms, 6 to 12 carbon atoms, 8 to 10 carbon atoms, or just 8 carbon atoms. These alcohols often have a 2-(C₁₋₄ alkyl) substituent, namely, methyl, ethyl, or any isomer of propyl or butyl. Examples of suitable alcohols include 2-methylheptanol, 2-methyldecanol, 2-ethylpentanol, 2-ethylhexanol, 2-ethylnonanol, 2-propylheptanol, 2-butylheptanol, 2-butyloctanol, isooctanol, dodecanol, cyclohexanol, methanol, ethanol, propan-1-ol, 2-methylpropan-2-ol, 2-methylpropan-1-ol, butan-1-ol, butan-2-ol, pentanol and its isomers, and mixtures thereof. In one embodiment the solvent is 2-ethylhexanol, 2-ethyl nonanol, 2-methylheptanol, or combinations thereof. In one embodiment the solvent includes 2-ethylhexanol.

### Succinimide Quaternary Ammonium Salts

In one embodiment the quaternary ammonium salt can comprise the reaction product of (i)(a) the condensation product of a hydrocarbyl-substituted acylating agent and a compound having an oxygen or nitrogen atom capable of condensing with said acylating agent where the condensation product has at least one tertiary amino group; and (ii) a quaternizing agent suitable for converting the tertiary amino group of compound (i) to a quaternary nitrogen.

Hydrocarbyl substituted acylating agents useful in the quaternary ammonium salt include the reaction product of a long chain hydrocarbon, generally a polyolefin, with a monounsaturated carboxylic acid or derivative thereof.

Suitable monounsaturated carboxylic acids or derivatives thereof include: (i) α,β-monounsaturated C₄ to C₁₀ dicarboxylic acids, such as fumaric acid, itaconic acid, maleic acid; (ii) derivatives of (i), such as anhydrides or C₁ to C₅ alcohol derived mono- or di-esters of (i); (iii) α,β-monounsaturated C₃ to C₁₀ monocarboxylic acids, such as acrylic acid and methacrylic acid; or (iv) derivatives of (iii), such as C₁ to C₅ alcohol derived esters of (iii).

Suitable long chain hydrocarbons for use in preparing the hydrocarbyl substituted acylating agents include any compound containing an olefinic bond represented by the general Formula I, shown here:

(R¹)(R²)C═C(R³)(CH(R⁴)(R⁵)) (I)

wherein each of R¹, R², R³, R⁴ and R⁵ is, independently, hydrogen or a hydrocarbon based group. In some embodiments at least one of R³, R⁴ or R⁵ is a hydrocarbon based group containing at least 20 carbon atoms.

These long chain hydrocarbons, which may also be described as polyolefins or olefin polymers, are reacted with the monounsaturated carboxylic acids and derivatives described above to form the hydrocarbyl substituted acylating agents. Suitable olefin polymers include polymers comprising a major molar amount of C₂ to C₂₀, or C₂ to C₅ mono-olefins. Such olefins include ethylene, propylene, butylene, isobutylene, pentene, octene-1, or styrene. The polymers may be homo-polymers, such as polyisobutylene, as well as copolymers of two or more of such olefins. Suitable copolymers include copolymers of ethylene and propylene, butylene and isobutylene, and propylene and isobutylene. Other suitable copolymers include those in which a minor molar amount of the copolymer monomers, e.g. 1 to 10 mole %, is a C₄ to C₁₈ di-olefin. Such copolymers include: a copolymer of isobutylene and butadiene; and a copolymer of ethylene, propylene and 1,4-hexadiene.

In one embodiment, at least one of the —R groups of Formula (I) shown above is derived from polybutene, that is, polymers of C₄ olefins, including 1-butene, 2-butene and isobutylene. C₄ polymers include polyisobutylene. In another embodiment, at least one of the —R groups of Formula I is derived from ethylene-alpha olefin polymers, including ethylene-propylene-diene polymers. Examples of documents that described ethylene-alpha olefin copolymers and ethylene-lower olefin-diene ter-polymers include U.S. Pat. Nos. 3,598,738; 4,026,809; 4,032,700; 4,137,185; 4,156,061; 4,320,019; 4,357,250; 4,658,078; 4,668,834; 4,937,299; and 5,324,800.

In another embodiment, the olefinic bonds of Formula (I) are predominantly vinylidene groups, represented by the following formula:

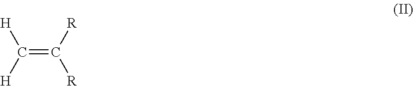

wherein each R is a hydrocarbyl group; which in some embodiments may be:

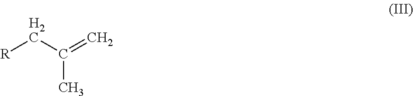

wherein R is a hydrocarbyl group.

In one embodiment, the vinylidene content of Formula (I) may comprise at least 30 mole % vinylidene groups, at least 50 mole % vinylidene groups, or at least 70 mole % vinylidene groups. Such materials and methods of preparation are described in U.S. Pat. Nos. 5,071,919; 5,137,978; 5,137,980; 5,286,823, 5,408,018, 6,562,913, 6,683,138, 7,037,999; and United States publications: 2004/0176552A1; 2005/0137363; and 2006/0079652A1. Such products are commercially available from BASF, under the trade name GLISSOPAL™ and from Texas PetroChemical LP, under the trade name TPC 1105™ and TPC 595™.

Methods of making hydrocarbyl substituted acylating agents from the reaction of monounsaturated carboxylic acid reactants and compounds of Formula (I) are well known in the art and disclosed in: U.S. Pat. Nos. 3,361,673; 3,401,118; 3,087,436; 3,172,892; 3,272,746, 3,215,707; 3,231,587; 3,912,764; 4,110,349; 4,234,435; 6,077,909; and 6,165,235.

In another embodiment, the hydrocarbyl substituted acylating agent can be made from the reaction of a compound represented by Formula (I) with at least one carboxylic reactant represented by the following formulas:

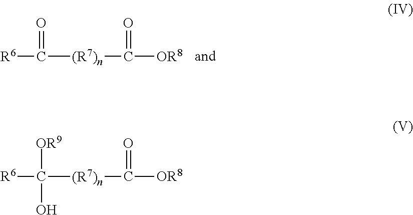

wherein each of R⁶, R⁸ and R⁹ is independently H or a hydrocarbyl group, R⁷ is a divalent hydrocarbylene group, and n is 0 or 1. Such compounds and the processes for making them are disclosed in U.S. Pat. Nos. 5,739,356; 5,777,142; 5,786,490; 5,856,524; 6,020,500; and 6,114,547.

In yet another embodiment, the hydrocarbyl substituted acylating agent may be made from the reaction of any compound represented by Formula (I) with any compound represented by Formula (IV) or Formula (V), where the reaction is carried out in the presence of at least one aldehyde or ketone. Suitable aldehydes include formaldehyde, acetaldehyde, propionaldehyde, butyraldehyde, isobutyraldehyde, pentanal, hexanal. heptaldehyde, octanal, benzaldehyde, as well as higher aldehydes. Other aldehydes, such as dialdehydes, especially glyoxal, are useful, although monoaldehydes are generally preferred. In one embodiment, the aldehyde is formaldehyde, which may be supplied in the aqueous solution often referred to as formalin, but which is more often used in the polymeric form referred to as paraformaldehyde. Paraformaldehyde is considered a reactive equivalent of and/or source of formaldehyde. Other reactive equivalents include hydrates or cyclic trimers. Suitable ketones include acetone, butanone, methyl ethyl ketone, as well as other ketones. In some embodiments, one of the two hydrocarbyl groups of the ketone is a methyl group. Mixtures of two or more aldehydes and/or ketones are also useful. Such hydrocarbyl substituted acylating agents and the processes for making them are disclosed in U.S. Pat. Nos. 5,840,920; 6,147,036; and 6,207,839.

In another embodiment, the hydrocarbyl substituted acylating agent may include methylene bis-phenol alkanoic acid compounds. Such compounds may be the condensation product of (i) an aromatic compound of the formula:

Rₘ—Ar—Z_{c} (VI)

and (ii) at least on carboxylic reactant such as the compounds of formula (IV) and (V) described above, wherein, in Formula (VI): each R is independently a hydrocarbyl group; m is 0 or an integer from 1 up to 6 with the proviso that m does not exceed the number of valences of the corresponding Ar group available for substitution; Ar is an aromatic group or moiety containing from 5 to 30 carbon atoms and from 0 to 3 optional substituents such as amino, hydroxy- or alkyl-polyoxyalkyl, nitro, aminoalkyl, and carboxy groups, or combinations of two or more of said optional substituents; Z is independently —OH, —O, a lower alkoxy group, or —(OR¹⁰)_{b}OR¹¹ wherein each R¹⁰ is independently a divalent hydrocarbyl group, b is a number from 1 to 30, and R¹¹ is —H or a hydrocarbyl group; and c is a number ranging from 1 to 3.

In one embodiment, at least one hydrocarbyl group on the aromatic moiety is derived from polybutene. In one embodiment, the source of the hydrocarbyl groups described above are polybutenes obtained by polymerization of isobutylene in the presence of a Lewis acid catalyst such as aluminum trichloride or boron trifluoride. Such compounds and the processes for making them are disclosed in U.S. Pat. Nos. 3,954,808; 5,336,278; 5,458,793; 5,620,949; 5,827,805; and 6,001,781.

In another embodiment, the reaction of (i) with (ii), optionally in the presence of an acidic catalyst such as organic sulfonic acids, heteropolyacids, and mineral acids, can be carried out in the presence of at least one aldehyde or ketone. The aldehyde or ketone reactant employed in this embodiment is the same as those described above. Such compounds and the processes for making them are disclosed in U.S. Pat. No. 5,620,949. Still other methods of making suitable hydrocarbyl substituted acylating agents can be found in U.S. Pat. Nos. 5,912,213; 5,851,966; and 5,885,944.

The succinimide quaternary ammonium salt can be derived by reacting the hydrocarbyl substituted acylating agent described above with a compound having an oxygen or nitrogen atom capable of condensing with the acylating agent. In one embodiment, suitable compounds contain at least one tertiary amino group or may be alkylated until they contain a tertiary amino group, so long as the hydrocarbyl substituted acylating agent has at least one tertiary amino group when it is reacted with the quaternizing agent.

In one embodiment, this compound may be represented by one of the following formulas:

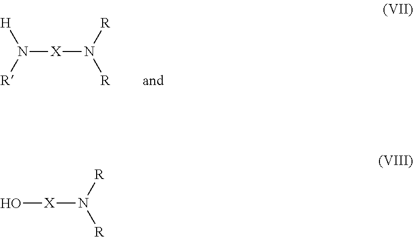

Wherein, for both Formulas (VII) and (VIII), each X is independently a alkylene group containing 1 to 4 carbon atoms; and each R is independently a hydrocarbyl group and R′ is a hydrogen or a hydrocarbyl group.

Suitable compounds include but are not limited to: 1-aminopiperidine, 1-(2-aminoethyl)piperidine, 1-(3-aminopropyl)-2-pipecoline, 1-methyl-(4-methylamino)piperidine, 1-amino-2,6-dimethylpiperidine, 4-(1-pyrrolidinyl)piperidine, 1-(2-aminoethyl)pyrrolidine, 2-(2-aminoethyl)-1-methylpyrrolidine, N,N-diethylethylenediamine, N,N-dimethylethylenediamine, N,N-dibutylethylenediamine, N,N,N′-trimethylethylenediamine, N,N-dimethyl-N′-ethylethylenediamine, N,N-diethyl-N′-methylethylenediamine, N,N,N′-triethylethylenediamine, 3-dimethylaminopropylamine, 3-diethylaminopropyl-amine, 3-dibutyl aminopropylamine, N,N,N′-trimethyl-1,3-propanediamine, N,N,2,2-tetramethyl-1,3-propanediamine, 2-amino-5-diethylaminopentane, N,N,N′,N′-tetraethyldiethylenetriamine, 3,3′-diamino-N-methyldipropylamine, 3,3′-iminobis(N,N-dimethylpropylamine), or combinations thereof. In some embodiments the amine used is 3-dimethylaminopropylamine, 3-diethylamino-propylamine, 1-(2-aminoethyl)pyrrolidine, N,N-dimethylethylenediamine, or combinations thereof.

Suitable compounds further include aminoalkyl substituted heterocyclic compounds such as 1-(3-aminopropyl)imidazole and 4-(3-aminopropyl)morpholine, 1-(2-aminoethyl)piperidine, 3,3-diamino-N-methyldipropylamine, 3,3′-aminobis(N,N-dimethylpropylamine) These have been mentioned in previous list.

Still further nitrogen or oxygen containing compounds capable of condensing with the acylating agent which also have a tertiary amino group include: alkanolamines, including but not limited to triethanolamine, N,N-dimethylaminopropanol, N,N-diethylaminopropanol, and N,N-diethylaminobutanol, N,N,N-tris(hydroxyethyl)amine.

The succinimide quaternary ammonium salt can be formed by combining the reaction product described above (the reaction product of a hydrocarbyl-substituted acylating agent and a compound having an oxygen or nitrogen atom capable of condensing with said acylating agent and further having at least one tertiary amino group) with a quaternizing agent suitable for converting the tertiary amino group to a quaternary nitrogen. Suitable quaternizing agents are discussed in greater detail below. In some embodiments these preparations may be carried out neat or in the presence of a solvent, as described above. By way of non-limiting example, preparations of succinimide quaternary ammonium salts are provided below.

In some embodiments the quaternary ammonium salts are substantially free of, or even completely free of, the succinimide quaternary ammonium salts described above.

### Polyalkene-Substituted Amine Quaternary Ammonium Salts

In one embodiment the quaternary ammonium salt is the reaction product of: (i)(b) a polyalkene-substituted amine having at least one tertiary amino group; and (ii) a quaternizing agent suitable for converting the tertiary amino group of compound (i) to a quaternary nitrogen.

Suitable polyalkene-substituted amines may be derived from an olefin polymer and an amine, such as ammonia, monoamines, polyamines or mixtures thereof. They may be prepared by a variety of methods. Suitable polyalkene-substituted amines or the amines from which they are derived either contain a tertiary amino group or may be alkylated until they contain a tertiary amino group, so long as the polyalkene-substituted amine has at least one tertiary amino group when it is reacted with the quaternizing agent.

One method of preparation of a polyalkene-substituted amine involves reacting a halogenated olefin polymer with an amine, as disclosed in U.S. Pat. Nos. 3,275,554; 3,438,757; 3,454,555; 3,565,804; 3,755,433; and 3,822,289. Another method of preparation of a polyalkene-substituted amine involves reaction of a hydro-formylated olefin with a polyamine and hydrogenating the reaction product, as disclosed in U.S. Pat. Nos. 5,567,845 and 5,496,383. Another method for preparing a polyalkene-substituted amine involves converting a polyalkene, by means of a conventional epoxidation reagent, with or without a catalyst, into the corresponding epoxide and converting the epoxide into the polyalkene substituted amine by reaction with ammonia or an amine under the conditions of reductive amination, as disclosed in U.S. Pat. No. 5,350,429. Another method for preparing a polyalkene-substituted amine involves hydrogenation of a β-aminonitrile, made by reacting an amine with a nitrile, as disclosed in U.S. Pat. No. 5,492,641. Yet another method for preparing a polyalkene-substituted amine involves hydroformylating polybutene or polyisobutylene, with a catalyst, such as rhodium or cobalt, in the presence of CO, H₂ and NH₃ at elevated pressures and temperatures, as disclosed in U.S. Pat. Nos. 4,832,702; 5,496,383 and 5,567,845. The above methods for the preparation of polyalkene substituted amine are for illustrative purposes only and are not meant to be an exhaustive list. The polyalkene-substituted amines disclosed herein are not limited in scope to the methods of their preparation disclosed hereinabove.

The polyalkene-substituted amine may be derived from olefin polymers. Suitable olefin polymers for preparing the polyalkene-substituted amines disclosed herein are the same as those described above.

The polyalkene-substituted amine may be derived from ammonia, monoamines, polyamines, or mixtures thereof, including mixtures of different monoamines, mixtures of different polyamines, and mixtures of monoamines and polyamines (which include diamines). Suitable amines include aliphatic, aromatic, heterocyclic and carbocyclic amines.

In one embodiment, the amines may be characterized by the formula:

R¹²R¹³NH (IX)

wherein R¹² and R¹³ are each independently hydrogen, hydrocarbon, amino-substituted hydrocarbon, hydroxy-substituted hydrocarbon, alkoxy-substituted hydrocarbon, or acylimidoyl groups provided that no more than one of R¹² and R¹³ is hydrogen. The amine may be characterized by the presence of at least of at least one primary (H₂N—) or secondary amino (H—N<) group. These amines, or the polyalkene-substituted amines they are used to prepare may be alkylated as needed to ensure they contain at least one tertiary amino group. Examples of suitable monoamines include ethylamine, dimethylamine, diethylamine, n-butylamine, dibutylamine, allylamine, isobutylamine, cocoamine, stearylamine, laurylamine, methyllaurylamine, oleylamine, N-methyl-octylamine, dodecyl-amine, diethanolamine, morpholine, and octadecylamine.

The polyamines from which the quaternary ammonium salt can be derived include principally alkylene amines conforming, for the most part, to the formula:

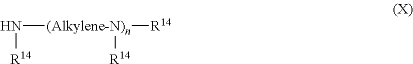

wherein n is an integer typically less than 10, each R¹⁴ is independently hydrogen or a hydrocarbyl group typically having up to 30 carbon atoms, and the alkylene group is typically an alkylene group having less than 8 carbon atoms. The alkylene amines include principally, ethylene amines, hexylene amines, heptylene amines, octylene amines, other polymethylene amines. They are exemplified specifically by: ethylenediamine, diethylenetriamine, triethylene tetramine, propylene diamine, decamethylene diamine, octamethylene diamine, di(heptamethylene)triamine, tripropylene tetramine, tetraethylene pentamine, trimethylene diamine, pentaethylene hexamine, di(-trimethylene)triamine, aminopropylmorpholine and dimethylaminopropylamine. Higher homologues such as are obtained by condensing two or more of the above-illustrated alkylene amines likewise are useful. Tetraethylene pentamine is particularly useful.

The ethylene amines, also referred to as polyethylene polyamines, are especially useful. They are described in some detail under the heading “Ethylene Amines” in Encyclopedia of Chemical Technology, Kirk and Othmer, Vol. 5, pp. 898-905, Interscience Publishers, New York (1950).

Any of the above polyalkene-substituted amines, or the amines from which they are derived, which are secondary or primary amines, may be alkylated to tertiary amines using alkylating agents before or while they are reacted with the quaternizing agents to form the quaternary ammonium salt additives. Suitable alkylating agents include the quaternizing agents discussed below.

The polyalkene-substituted amine quaternary ammonium salts can be formed by combining the reaction product described above (the polyalkene-substituted amine, having at least one tertiary amino group) with a quaternizing agent suitable for converting the tertiary amino group to a quaternary nitrogen. Suitable quaternizing agents are discussed in greater detail below. By way of non-limiting example, a preparation of a polyalkene-substituted amine quaternary ammonium salt is provided below.

In some embodiments the quaternary ammonium salts can be substantially free of, or even completely free of, the polyalkene-substituted amine quaternary ammonium salts described above.

### Mannich Quaternary Ammonium Salts

In one embodiment the quaternary ammonium salt is the reaction product of: (i)(c) a Mannich reaction product; and (ii) a quaternizing agent suitable for converting the tertiary amino group of compound (i) to a quaternary nitrogen. Suitable Mannich reaction products have at least one tertiary amino group and are prepared from the reaction of a hydrocarbyl-substituted phenol, an aldehyde, and an amine.

The hydrocarbyl substituent of the hydrocarbyl-substituted phenol can have 10 to 400 carbon atoms, in another instance 30 to 180 carbon atoms, and in a further instance 10 or 40 to 110 carbon atoms. This hydrocarbyl substituent can be derived from an olefin or a polyolefin. Useful olefins include alpha-olefins, such as 1-decene, which are commercially available. Suitable polyolefins include those described in the sections above. The hydrocarbyl-substituted phenol can be prepared by alkylating phenol with one of these suitable olefins or polyolefins, such as a polyisobutylene or polypropylene, using well-known alkylation methods.

The aldehyde used to form the Mannich quaternary ammonium salt can have 1 to 10 carbon atoms, and is generally formaldehyde or a reactive equivalent thereof, such as formalin or paraformaldehyde.

The amine used to form the Mannich quat can be a monoamine or a polyamine. Amines suitable for preparing the Mannich reaction product can be the same as those are described in the sections above.

In one embodiment, the Mannich quat is prepared by reacting a hydrocarbyl-substituted phenol, an aldehyde, and an amine, as described in U.S. Pat. No. 5,697,988. In one embodiment, the Mannich reaction product is prepared from: an alkylphenol derived from a polyisobutylene; formaldehyde; and a primary monoamine, secondary monoamine, or alkylenediamine. In some of such embodiments the amine is ethylenediamine or dimethylamine. Other methods of preparing suitable Mannich reaction products can be found in U.S. Pat. Nos. 5,876,468 and 5,876,468.

As discussed above, it may be necessary, with some of the amines, to further react the Mannich reaction product with an epoxide or carbonate, or other alkylating agent, in order to obtain the tertiary amino group.

The Mannich quaternary ammonium salts can be formed by combining the reaction product described above (the Mannich reaction product with at least one tertiary amino group) with a quaternizing agent suitable for converting the tertiary amino group to a quaternary nitrogen. Suitable quaternizing agents are discussed below.

In some embodiments the quaternary ammonium salts can be substantially free of, or even completely free of, the Mannich quaternary ammonium salts described above.

Amide and/or Ester Quaternary Ammonium Salts

In some embodiments the quaternary ammonium salts disclosed herein can be quaternary amides and/or esters which may be described as the reaction product of: (i) a non-quaternized amide and/or ester having a tertiary amine functionality; and (ii) a quaternizing agent. In some embodiments the non-quaternized amide and/or ester is the condensation product of (a) a hydrocarbyl-substituted acylating agent and (b) a compound having an oxygen or nitrogen atom capable of condensing with said acylating agent and further having at least one tertiary amino group.

The non-quaternized amide and/or ester suitable for use can include the condensation product of (i) a hydrocarbyl-substituted acylating agent and (ii) a compound having an oxygen or nitrogen atom capable of condensing with said acylating agent and further having at least one tertiary amino group, where the resulting amide and/or ester has at least one tertiary amino group and also contains an amide group and/or an ester group. Typically, the compound having an oxygen or nitrogen atom capable of condensing with said acylating agent determines whether the resulting compound contains an amide group or an ester group. In some embodiments, the non-quaternized amide and/or ester, and so the resulting quaternized amide and/or ester is free of any imide groups. In some embodiments, the non-quaternized amide and/or ester, and so the resulting quaternized amide and/or ester is free of any ester groups. In these embodiments the compound contains at least one, or just one, amide group.

The hydrocarbyl substituted acylating agent can be any of the materials described in section above provided that the material contains an amide group and/or an ester group.

The non-quaternized amide and/or ester used to prepare the additives are themselves formed when the acylating agents described above are reacted with a compound having an oxygen or nitrogen atom capable of condensing with the acylating agent which further has at least one tertiary amino group. Any of these compounds described above may be used here as well.

The quaternary amide and/or esters are prepared by reacting (a) the non-quaternized amide and/or ester having a tertiary amine functionality with (b) the quaternizing agent; thereby obtaining the quaternized amide and/or ester. The processes disclosed herein may also be described as a process for preparing a quaternized amide and/or ester comprising the steps of: (1) mixing (a) a non-quaternized amide and/or ester having an amine functionality, (b) a quaternizing agent and optionally with (c) a protic solvent, which in some embodiments is free of methanol; (2) heating the mixture to a temperature between 50° C. to 130° C.; and (3) holding for the reaction to complete; thereby obtaining the quaternized amide and/or ester. In one embodiment the reaction is carried out at a temperature of less than 80° C., or less than 70° C. In other embodiments the reaction mixture is heated to a temperature of about 50° C. to 120° C., 80° C., or 70° C. In still other embodiments where the hydrocarbyl acylating agent is derived from a monocarboxylic acid, the reaction temperature may be 70° C. to 130° C. In other embodiments where the hydrocarbyl acylating agent is derived from a dicarboxylic acid, the reaction temperature may be 50° C. to 80° C. or 50° C. to 70° C. In some embodiments the processes disclosed herein can be free of the addition of any acid reactant, such as acetic acid. The salt product is obtained in these embodiments despite the absence of the separate acid reactant.

As described above, in some embodiments the non-quaternized amide and/or ester is the condensation product of hydrocarbyl-substituted acylating agent and a compound having an oxygen or nitrogen atom capable of condensing with said acylating agent and further having at least one tertiary amino group. Suitable quaternizing agents and compounds having an oxygen or nitrogen atom are also described above.

The quaternary ammonium salts may be derived in the presence of a protic solvent. In some embodiments the process used to prepare these additives is substantially free of to free of methanol. Substantially free of methanol can mean less than 0.5, 0.1 or 0.05 percent by weight methanol in the reaction mixture, and may also mean completely free of methanol.

Suitable protic solvents include solvents that have dielectric constants of greater than 9. In one embodiment the protic solvent includes compounds that contain 1 or more hydroxyl functional groups, and may include water.

In one embodiment, the solvents are glycols and glycol ethers. Glycols containing from 2 to 12 carbon atoms, or from 4 to 10, or 6 to 8 carbon atoms, and oligomers thereof (e.g., dimers, trimers and tetramers) are generally suitable for use. Illustrative glycols include ethylene glycol, propylene glycol, diethylene glycol, dipropylene glycol, 1,4-butanediol, 2-methyl-1,3-propanediol, neopentyl glycol, triethylene glycol, polyethylene glycol and the like and oligomers and polymeric derivative and mixtures thereof. Illustrative glycol ethers include the C₁-C₆ alkyl ethers of propylene glycol, ethylene glycol and oligomers thereof such as di-, tri- and tetra glycol ethers of methyl, ethyl, propyl, butyl or hexyl. Suitable glycol ethers include ethers of dipropylene glycol, tripropylene glycol diethylene glycol, triethylene glycol; ethyl diglycol ether, butyl diglycol ether, methoxytriglycol, ethoxytriglycol, butoxytriglycol, methoxytetraglycol, butoxytetraglycol.

Suitable solvents for use in preparing the quaternary ammonium salts can also include certain alcohols. In one embodiment, these alcohols contain at least 2 carbon atoms, and in other embodiments at least 4, at least 6 or at least 8 carbon atoms. In another embodiment, the solvent contains 2 to 20 carbon atoms, 4 to 16 carbon atoms, 6 to 12 carbon atoms, 8 to 10 carbon atoms, or just 8 carbon atoms. These alcohols normally have a 2-(C₁₋₄ alkyl) substituent, namely, methyl, ethyl, or any isomer of propyl or butyl. Examples of suitable alcohols include 2-methylheptanol, 2-methyldecanol, 2-ethylpentanol, 2-ethylhexanol, 2-ethylnonanol, 2-propylheptanol, 2-butylheptanol, 2-butyloctanol, isooctanol, dodecanol, cyclohexanol, methanol, ethanol, propan-1-ol, 2-methylpropan-2-ol, 2-methylpropan-1-ol, butan-1-ol, butan-2-ol, pentanol and its isomers, and mixtures thereof. In one embodiment the solvent is 2-ethylhexanol, 2-ethyl nonanol, 2-propylheptanol, or combinations thereof. In one embodiment the solvent includes 2-ethylhexanol.

The solvent can be any of the commercially available alcohols or mixtures of such alcohols and also includes such alcohols and mixtures of alcohols mixed with water. In some embodiments the amount of water present may be above 1 percent by weight of the solvent mixture. In other embodiments the solvent mixture may contain traces of water, with the water content being less than 1 or 0.5 percent by weight.

The alcohols can be aliphatic, cycloaliphatic, aromatic, or heterocyclic, including aliphatic-substituted cycloaliphatic alcohols, aliphatic-substituted aromatic alcohols, aliphatic-substituted heterocyclic alcohols, cycloaliphatic-substituted aliphatic alcohols, cycloaliphatic-substituted aromatic alcohols, cycloaliphatic-substituted heterocyclic alcohols, heterocyclic-substituted aliphatic alcohols, heterocyclic-substituted cycloaliphatic alcohols, and heterocyclic-substituted aromatic alcohols.

While not wishing to be bound by theory, it is believed that a polar protic solvent is required in order to facilitate the dissociation of the acid into ions and protons. The dissociation is required to protonate the ion formed when the compound having an amine functionality initially reacts with the quaternizing agent. In the case where the quaternizing agent is an alkyl epoxide the resulting ion would be an unstable alkoxide ion. The dissociation also provides a counter ion from the acid group of the additive that acts to stabilize the quaternary ammonium ion formed in the reaction, resulting in a more stable product.

The solvent may be present such that the weight ratio of the amount of compound having an amine functionality to the amount of polar solvent is in one set of embodiments from 20:1 to 1:20; or from 10:1 to 1:10. In additional embodiments, the compound to solvent weight ratio can be from 1:10 to 1:15; from 15:1 to 10:1; or from 5:1 to 1:1.

In some embodiments the quaternary ammonium salts can be substantially free of, or even completely free of, the quaternary amide and/or esters described above.

### Polyester Quaternary Ammonium Salts

In some embodiments the quaternary ammonium salt is a polyester quaternary salt, which may include quaternized polyester amine, amide, and ester salts. Such additives may also be described as quaternary polyester salts. The quaternary ammonium salts may be described as the reaction product of: a polyester containing a tertiary amino group; and a quaternizing agent suitable for converting the tertiary amino group to a quaternary nitrogen. The quaternary agents may be any of the agents described herein.

The polyester containing a tertiary amino group used in the preparation of the quaternary ammonium salts may also be described as a non-quaternized polyester containing a tertiary amino group.

In some embodiments the polyester is the reaction product of a fatty carboxylic acid containing at least one hydroxyl group and a compound having an oxygen or nitrogen atom capable of condensing with said acid further having a tertiary amino group. Suitable fatty carboxylic acids to use in the preparation of the polyesters described above may be represented by the formula:

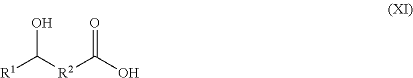

where R¹ is a hydrogen or a hydrocarbyl group containing from 1 to 20 carbon atoms and R² is a hydrocarbylene group containing from 1 to 20 carbon atoms. In some embodiments R¹ contains from 1 to 12, 2 to 10, 4 to 8 or even 6 carbon atoms, and R² contains from 2 to 16, 6 to 14, 8 to 12, or even 10 carbon atoms.

In some embodiments the fatty carboxylic acid used in the preparation of the polyester is 12-hydroxystearic acid, ricinoleic acid, 12-hydroxy dodecanoic acid, 5-hydroxy dodecanoic acid, 5-hydroxy decanoic acid, 4-hydroxy decanoic acid, 10-hydroxy undecanoic acid, or combinations thereof.

In some embodiments the compound having an oxygen or nitrogen atom capable of condensing with said acid and further having a tertiary amino group is represented by the formula:

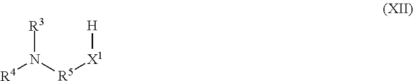

where R³ is a hydrocarbyl group containing from 1 to 10 carbon atoms; R⁴ is a hydrocarbyl group containing from 1 to 10 carbon atoms; R⁵ is a hydrocarbylene group containing from 1 to 20 carbon atoms; and X¹ is O or NR⁶ where R⁶ is a hydrogen or a hydrocarbyl group containing from 1 to 10 carbon atoms. In some embodiments R³ contains from 1 to 6, 1 to 2, or even 1 carbon atom, R⁴ contains from 1 to 6, 1 to 2, or even 1 carbon atom, R⁵ contains from 2 to 12, 2 to 8 or even 3 carbon atoms, and R⁶ contains from 1 to 8, or 1 to 4 carbon atoms. In some of these embodiments, formula (XII) becomes:

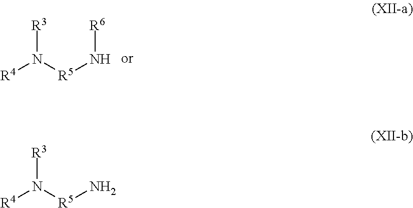

where the various definitions provided above still apply.

Examples of nitrogen or oxygen containing compounds capable of condensing with the acylating agents, which also have a tertiary amino group, or compounds that can be alkylated into such compounds, include any of the materials described in the sections above.

The nitrogen or oxygen containing compounds may further include aminoalkyl substituted heterocyclic compounds such as 1-(3-aminopropyl)imidazole and 4-(3-aminopropyl)morpholine.

In one embodiment the nitrogen or oxygen containing compound is triisopropanolamine, 1-[2-hydroxyethyl]piperidine, 2-[2-(dimethylamino) ethoxy]-ethanol, N-ethyldiethanolamine, N-methyldiethanolamine, N-butyldiethanolamine, N,N-diethylaminoethanol, N,N-dimethylaminoethanol, 2-dimethylamino-2-methyl-1-propanol, or combinations thereof.

In some embodiments the compound having an oxygen or nitrogen atom capable of condensing with said acid and further having a tertiary amino group comprises N,N-diethylethylenediamine, N,N-dimethylethylenediamine, N,N-dibutylethylenediamine, N,N-dimethyl-1,3-diaminopropane, N,N-diethyl-1,3-diaminopropane, N,N-dimethyl amino ethanol, N,N-diethylaminoethanol, or combinations thereof.

The quaternized polyester salt can be a quaternized polyester amide salt. In such embodiments the polyester containing a tertiary amino group used to prepare the quaternized polyester salt is a polyester amide containing a tertiary amino group. In some of these embodiments the amine or aminoalcohol is reacted with a monomer and then the resulting material is polymerized with additional monomer, giving the polyester amide which may then be quaternized.

In some embodiments the quaternized polyester salt includes a cation represented by the following formula:

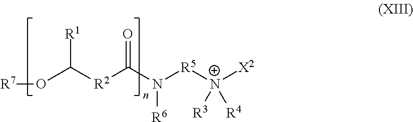

where R¹ is a hydrogen or a hydrocarbyl group containing from 1 to 20 carbon atoms and R² is a hydrocarbylene group containing from 1 to 20 carbon atoms; R³ is a hydrocarbyl group containing from 1 to 10 carbon atoms; R⁴ is a hydrocarbyl group containing from 1 to 10 carbon atoms; R⁵ is a hydrocarbylene group containing from 1 to 20 carbon atoms; R⁶ is a hydrogen or a hydrocarbyl group containing from 1 to 10 carbon atoms; n is a number from 1 to 20 or from 1 to 10; R⁷ is hydrogen, a hydrocarbonyl group containing from 1 to 22 carbon atoms, or a hydrocarbyl group containing from 1 to 22 carbon atoms; and X² is a group derived from the quaternizing agent. In some embodiments R⁶ is hydrogen.

As above, in some embodiments R¹ contains from 1 to 12, 2 to 10, 4 to 8 or even 6 carbon atoms, and R² contains from 1 or even 2 to 16, 6 to 14, 8 to 12, or even 10 carbon atoms, R³ contains from 1 to 6, 1 to 2, or even 1 carbon atom, R⁴ contains from 1 to 6, 1 to 2, or even 1 carbon atom, R⁵ contains from 2 to 12, 2 to 8 or even 3 carbon atoms, and R⁶ contains from 1 to 8, or 1 to 4 carbon atoms. In any of these embodiments n may be from 2 to 9, or 3 to 7, and R⁷ may contain from 6 to 22, or 8 to 20 carbon atoms. R⁷ may be an acyl group.

In these embodiments the quaternized polyester salt is essentially capped with a C1-22, or a C8-20, fatty acid. Examples of suitable acids include oleic acid, palmitic acid, stearic acid, erucic acid, lauric acid, 2-ethylhexanoic acid, 9,11-linoleic acid, 9,12-linoleic acid, 9,12,15-linolenic acid, abietic acid, or combinations thereof.

The number average molecular weight (Mn) of the quaternized polyester salts may be from 500 to 3000, or from 700 to 2500.

The polyester useful herein can be obtained by heating one or more hydroxycarboxylic acids or a mixture of the hydroxycarboxylic acid and a carboxylic acid, optionally in the presence of an esterification catalyst. The hydroxycarboxylic acids can have the formula HO—X—COOH wherein X is a divalent saturated or unsaturated aliphatic radical containing at least 8 carbon atoms and in which there are at least 4 carbon atoms between the hydroxy and carboxylic acid groups, or from a mixture of such a hydroxycarboxylic acid and a carboxylic acid which is free from hydroxy groups. This reaction can be carried out at a temperature in the region of 160 C to 200 C, until the desired molecular weight has been obtained. The course of the esterification can be followed by measuring the acid value of the product, with the desired polyester, in some embodiments, having an acid value in the range of 10 to 100 mg KOH/g or in the range of 20 to 50 mg KOH/g. The indicated acid value range of 10 to 100 mg KOH/g is equivalent to a number average molecular weight range of 5600 to 560. The water formed in the esterification reaction can be removed from the reaction medium, and this can be conveniently done by passing a stream of nitrogen over the reaction mixture or, by carrying out the reaction in the presence of a solvent, such as toluene or xylene, and distilling off the water as it is formed.

The resulting polyester can then be isolated in conventional manner; however, when the reaction is carried out in the presence of an organic solvent whose presence would not be harmful in the subsequent application, the resulting solution of the polyester can be used.

In the said hydroxycarboxylic acids the radical represented by X may contain from 12 to 20 carbon atoms, optionally where there are between 8 and 14 carbon atoms between the carboxylic acid and hydroxy groups. In some embodiments the hydroxy group is a secondary hydroxy group.

Specific examples of such hydroxycarboxylic acids include ricinoleic acid, a mixture of 9- and 10-hydroxystearic acids (obtained by sulphation of oleic acid and then hydrolysis), and 12-hydroxystearic acid, and the commercially available hydrogenated castor oil fatty acid which contains in addition to 12-hydroxystearic acid minor amounts of stearic acid and palmitic acid.

The carboxylic acids which can be used in conjunction with the hydroxycarboxylic acids to obtain these polyesters are preferably carboxylic acids of saturated or unsaturated aliphatic compounds, particularly alkyl and alkenyl carboxylic acids containing a chain of from 8 to 20 carbon atoms. As examples of such acids there may be mentioned lauric acid, palmitic acid, stearic acid and oleic acid.

In one embodiment the polyester is derived from commercial 12-hydroxy-stearic acid having a number average molecular weight of about 1600. Polyesters such as this are described in greater detail in U.K. Patent Specification Nos. 1373660 and 1342746.

In some embodiments the components used to prepare the additives described above are substantially free of, essentially free of, or even completely free of, non-polyester-containing hydrocarbyl substituted acylating agents and/or non-polyester-containing hydrocarbyl substituted diacylating agents, such as for example polyisobutylene. In some embodiments these excluded agents are the reaction product of a long chain hydrocarbon, generally a polyolefin reacted with a monounsaturated carboxylic acid reactant, such as, (i) α,β-monounsaturated C₄ to C₁₀ dicarboxylic acid, such as, fumaric acid, itaconic acid, maleic acid.; (ii) derivatives of (i) such as anhydrides or C₁ to C₅ alcohol derived mono- or di-esters of (i); (iii) α,β-monounsaturated C₃ to C₁₀ monocarboxylic acid such as acrylic acid and methacrylic acid.; or (iv) derivatives of (iii), such as, C₁ to C₅ alcohol derived esters of (iii) with any compound containing an olefinic bond represented by the general formula (R⁹)(R¹⁰)C═C(R¹¹)(CH(R⁷)(R⁸)) wherein each of R⁹ and R¹⁰ is independently hydrogen or a hydrocarbon based group; each of R¹¹, R⁷ and R⁸ is independently hydrogen or a hydrocarbon based group and preferably at least one is a hydrocarbyl group containing at least 20 carbon atoms. In one embodiment, the excluded hydrocarbyl-substituted acylating agent is a dicarboxylic acylating agent. In some of these embodiments, the excluded hydrocarbyl-substituted acylating agent is polyisobutylene succinic anhydride.

By substantially free of, it is meant that the components are primarily composed of materials other than hydrocarbyl substituted acylating agents described above such that these agents are not significantly involved in the reaction and the compositions disclosed herein do not contain significant amounts of additives derived from such agents. In some embodiments the components, or the compositions disclosed herein, may contain less than 10 percent by weight of these agents, or of the additives derived from these agents. In other embodiments the allowable amount may be 5, 3, 2, 1 or even 0.5 or 0.1 percent by weight. One of the purposes of these embodiments is to allow the exclusion of agents such as polyisobutylene succinic anhydrides from the reactions disclosed herein and so, to also allow the exclusion of quaternized salt additive derived from agents such as polyisobutylene succinic anhydrides. The focus of this embodiment is on polyester, or hyperdispersant, quaternary salt additives.

In some embodiments the quaternary ammonium salts are substantially free of, or even completely free of, the polyester quaternary salts described above.

### The Quaternizing Agent

Suitable quaternizing agents for preparing any of the quaternary ammonium salts described above include dialkyl sulfates, benzyl halides, hydrocarbyl substituted carbonates, hydrocarbyl epoxides used in combination with an acid, esters of polycarboxylic acids, or mixtures thereof.

In one embodiment the quaternizing agent includes: halides such as chloride, iodide or bromide; hydroxides; sulphonates; alkyl sulphates such as dimethyl sulphate; sultones; phosphates; C₁₋₁₂ alkylphosphates; di-C₁₋₁₂ alkylphosphates; borates; C₁₋₁₂ alkylborates; nitrites; nitrates; carbonates; bicarbonates; alkanoates; O,O-di-C₁₋₁₂ alkyldithiophosphates; or mixtures thereof.

In one embodiment the quaternizing agent may be: a dialkyl sulphate such as dimethyl sulphate; N-oxides; sultones such as propane or butane sultone; alkyl, acyl or aralkyl halides such as methyl and ethyl chloride, bromide or iodide or benzyl chloride; hydrocarbyl (or alkyl) substituted carbonates; or combinations thereof. If the aralkyl halide is benzyl chloride, the aromatic ring is optionally further substituted with alkyl or alkenyl groups.

The hydrocarbyl (or alkyl) groups of the hydrocarbyl substituted carbonates may contain 1 to 50, 1 to 20, 1 to 10 or 1 to 5 carbon atoms per group. In one embodiment the hydrocarbyl substituted carbonates contain two hydrocarbyl groups that may be the same or different. Examples of suitable hydrocarbyl substituted carbonates include dimethyl or diethyl carbonate.

In another embodiment the quaternizing agent can be a hydrocarbyl epoxides, as represented by the following formula:

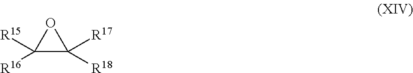

wherein R¹⁵, R¹⁶, R¹⁷ and R¹⁸ can be independently H or a C₁₋₅₀ hydrocarbyl group. Examples of suitable hydrocarbyl epoxides include: styrene oxide, ethylene oxide, propylene oxide, butylene oxide, stilbene oxide, C₂₋₅₀ epoxides, or combinations thereof.

In another embodiment the quaternizing agent can be an ester of a carboxylic acid capable of reacting with a tertiary amine to form a quaternary ammonium salt, or an ester of a polycarboxylic acid. In a general sense such materials may be described as compounds having the structure:

R¹⁹—C(═O)—O—R²⁰ (XV)

where R¹⁹ is an optionally substituted alkyl, alkenyl, aryl or alkylaryl group and R²⁰ is a hydrocarbyl group containing from 1 to 22 carbon atoms.

Suitable compounds include esters of carboxylic acids having a pKa of 3.5 or less. In some embodiments the compound is an ester of a carboxylic acid selected from a substituted aromatic carboxylic acid, an a-hydroxycarboxylic acid and a polycarboxylic acid. In some embodiments the compound is an ester of a substituted aromatic carboxylic acid and thus R¹⁹ is a substituted aryl group. R may be a substituted aryl group having 6 to 10 carbon atoms, a phenyl group, or a naphthyl group. R may be suitably substituted with one or more groups selected from carboalkoxy, nitro, cyano, hydroxy, SR′ or NR′R″ where each of R′ and R″ may independently be hydrogen, or an optionally substituted alkyl, alkenyl, aryl or carboalkoxy groups. In some embodiments R′ and R″ are each independently hydrogen or an optionally substituted alkyl group containing from 1 to 22, 1 to 16, 1 to 10, or even 1 to 4 carbon atoms.

In some embodiments R¹⁹ in the formula above is an aryl group substituted with one or more groups selected from hydroxyl, carboalkoxy, nitro, cyano and NH². R¹⁹ may be a poly-substituted aryl group, for example trihydroxyphenyl, but may also be a mono-substituted aryl group, for example an ortho substituted aryl group. R¹⁹ may be substituted with a group selected from OH, NH₂, NO₂, or COOMe. Suitably R¹⁹ is a hydroxy substituted aryl group. In some embodiments R¹⁹ is a 2-hydroxyphenyl group. R²⁰ may be an alkyl or alkylaryl group, for example an alkyl or alkylaryl group containing from 1 to 16 carbon atoms, or from 1 to 10, or 1 to 8 carbon atoms. R²⁰ may be methyl, ethyl, propyl, butyl, pentyl, benzyl or an isomer thereof. In some embodiments R²⁰ is benzyl or methyl. In some embodiments the quaternizing agent is methyl salicylate.

In some embodiments the quaternizing agent is an ester of an alpha-hydroxycarboxylic acid. Compounds of this type suitable for use herein are described in EP 1254889. Examples of suitable compounds which contain the residue of an alpha-hydroxycarboxylic acid include (i) methyl-, ethyl-, propyl-, butyl-, pentyl-, hexyl-, benzyl-, phenyl-, and allyl esters of 2-hydroxyisobutyric acid; (ii) methyl-, ethyl-, propyl-, butyl-, pentyl-, hexyl-, benzyl-, phenyl-, and allyl esters of 2-hydroxy-2-methylbutyric acid; (iii) methyl-, ethyl-, propyl-, butyl-, pentyl hexyl-, benzyl-, phenyl-, and allyl esters of 2-hydroxy-2-ethylbutyric acid; (iv) methyl-, ethyl-, propyl-, butyl-, pentyl-, hexyl-, benzyl-, phenyl-, and allyl esters of lactic acid; and (v) methyl-, ethyl-, propyl-, butyl-, pentyl-, hexyl-, allyl-, benzyl-, and phenyl esters of glycolic acid. In some embodiments the quaternizing agent comprises methyl 2-hydroxyisobutyrate.

In some embodiments the quaternizing agent comprises an ester of a polycarboxylic acid. In this definition we mean to include dicarboxylic acids and carboxylic acids having more than 2 acidic moieties. In some embodiments the esters are alkyl esters with alkyl groups that contain from 1 to 4 carbon atoms. Suitable example include diesters of oxalic acid, diesters of phthalic acid, diesters of maleic acid, diesters of malonic acid or diesters or triesters of citric acid.

In some embodiments the quaternizing agent is an ester of a carboxylic acid having a pKa of less than 3.5. In such embodiments in which the compound includes more than one acid group, we mean to refer to the first dissociation constant. The quaternizing agent may be selected from an ester of a carboxylic acid selected from one or more of oxalic acid, phthalic acid, salicylic acid, maleic acid, malonic acid, citric acid, nitrobenzoic acid, aminobenzoic acid and 2,4,6-trihydroxybenzoic acid. In some embodiments the quaternizing agent includes dimethyl oxalate, methyl 2-nitrobenzoate and methyl salicylate.

Any of the quaternizing agents described above, including the hydrocarbyl epoxides, may be used in combination with an acid. Suitable acids include carboxylic acids, such as acetic acid, propionic acid, 2-ethylhexanoic acid, and the like.

In some embodiments the quaternary ammonium salt includes the reaction product of: (i) a compound comprising at least one tertiary amino group; and (ii) a quaternizing agent suitable for converting the tertiary amino group of compound (i) to a quaternary nitrogen, where component (i), the compound comprising at least one tertiary amino group, comprises: (a) the condensation product of a hydrocarbyl-substituted acylating agent and a compound having an oxygen or nitrogen atom capable of condensing the acylating agent wherein the condensation product has at least one tertiary amino group.

In some embodiments the hydrocarbyl-substituted acylating agent may be polyisobutylene succinic acid or anhydride. The polyisobutylene of the polyisobutylene succinic acid or anhydride can have a number average molecular weight of from between about 150 to about 5000, or 200 to 4000, 225 to 3000, or 250 to 2500. The compound having an oxygen or nitrogen atom capable of condensing with said acylating agent may be dimethylaminopropylamine, N-methyl-1,3-diaminopropane, N,N-dimethylaminopropylamine, N,N-diethyl-aminopropylamine, N,N-dimethyl-aminoethylamine, diethylenetriamine, dipropylenetriamine, dibutylenetriamine, triethylenetetraamine, tetraethylenepentaamine, pentaethylenehexaamine, hexamethylenetetramine, and bis(hexamethylene)triamine.

In some embodiments the quaternary ammonium salt comprises an cation represented by the following formula:

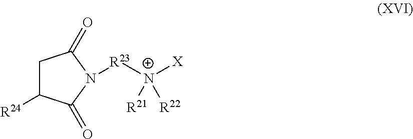

wherein: R²¹ is a hydrocarbyl group containing from 1 to 10 carbon atoms; R²² is a hydrocarbyl group containing from 1 to 10 carbon atoms; R²³ is a hydrocarbylene group containing from 1 to 20 carbon atoms; R²⁴ is a hydrocarbyl group containing from 50 to 150 carbon atoms; and X is a group derived from the quaternizing agent.

In some embodiments the quaternary ammonium salt includes the reaction product of: (i) a compound comprising at least one tertiary amino group; and (ii) a quaternizing agent suitable for converting the tertiary amino group of compound (i) to a quaternary nitrogen, where component (i), the compound comprising at least one tertiary amino group, comprises: (b) a polyalkene-substituted amine having at least one tertiary amino group.

In some embodiments the polyalkene substituent of the polyalkene-substituted amine is derived from polyisobutylene and the polyalkene-substituted amine has a number average molecular weight of about 500 to about 3000.

In some embodiments the quaternary ammonium salt includes the reaction product of: (i) a compound comprising at least one tertiary amino group; and (ii) a quaternizing agent suitable for converting the tertiary amino group of compound (i) to a quaternary nitrogen, where component (i), the compound comprising at least one tertiary amino group, comprises: (c) a Mannich reaction product having at least one tertiary amino group, wherein the Mannich reaction product is derived from a hydrocarbyl-substituted phenol, an aldehyde, and an amine.

In some embodiments component (i), the compound comprising at least one tertiary amino group, comprises a Mannich reaction product having a tertiary amino group, said Mannich reaction product being prepared from the reaction of a hydrocarbyl-substituted phenol, an aldehyde, and an amine; and wherein the hydrocarbyl substituent of the hydrocarbyl-substituted phenol of component (a) is derived from a polyolefin having a number average molecular weight of 400 to 3,000; wherein the aldehyde of component (a) is a formaldehyde or a reactive equivalent thereof; and wherein the amine of component (a) is selected from the group consisting of dimethylamine, ethylenediamine, dimethylaminopropylamine, diethylenetriamine, dibutylamine, and mixtures thereof.

In any of these embodiments described above, any of one or combination of quaternizing agents described above may be used.

### Oil of Lubricating Viscosity

The methods and compositions disclosed herein optionally can include an oil of lubricating viscosity, including natural or synthetic oils of lubricating viscosity, oil derived from hydrocracking, hydrogenation, hydrofinishing, unrefined, refined and re-refined oils, or mixtures thereof. In one embodiment the oil of lubricating viscosity is a carrier fluid for the dispersant and/or other performance additives.

Natural oils include animal oils, vegetable oils, mineral oils or mixtures thereof. Synthetic oils include a hydrocarbon oil, a silicon-based oil, a liquid ester of phosphorus-containing acid. Synthetic oils may be produced by Fischer-Tropsch reactions and typically may be hydroisomerised Fischer-Tropsch hydrocarbons or waxes.

Oils of lubricating viscosity may also be defined as specified in the American Petroleum Institute (API) Base Oil Interchangeability Guidelines. In one embodiment the oil of lubricating viscosity comprises an API Group I, II, III, IV, V or mixtures thereof, and in another embodiment API Group I, II, III or mixtures thereof. If the oil of lubricating viscosity is an API Group II, III, IV or V oil there may be up to about 40 wt % and in another embodiment up to about 5 wt % of the lubricating oil an API Group I oil.

### Other Performance Additive

Optionally the composition can further include at least one other performance additive. The other performance additive compounds include a metal deactivator, a detergent, an antiwear agent, an antioxidant, a corrosion inhibitor, a foam inhibitor, a demulsifiers, a pour point depressant, a seal swelling agent, one or more wax control polymers (including wax crystal modifiers and wax dispersants, such as ethylene vinyl acetate, fumarate vinyl acetate, copolymer esters or alkyl phenol resins), scale inhibitors including phosphate esters, gas-hydrate inhibitors (often known as freeze point depressant) including methanol or mixtures thereof.

The total combined amount of the other performance additive compounds present on an oil free basis in ranges from about 0 wt % to about 25 wt %, in another embodiment about 0.0005 wt % to about 25 wt %, in another embodiment about 0.001 wt % to about 20 wt % and in yet another embodiment about 0.002 wt % to about 15 wt % of the composition. Although one or more of the other performance additives may be present, it is common for the other performance additives to be present in different amounts relative to each other.

### Process

There is further provided a process for preparing a composition comprising the steps of mixing an oil of lubricating viscosity and a quaternary ammonium salt to form a dilute composition or a concentrate.

The components may be mixed sequentially and/or separately to form the dilute composition or concentrate. The mixing conditions include for a period of time in the range about 30 seconds to about 48 hours, in another embodiment about 2 minutes to about 24 hours, in another embodiment about 5 minutes to about 16 hours and in yet another embodiment about 10 minutes to about 5 hours; and at pressures in the range including about 86 kPa to about 500 kPa (about 650 mm Hg to about 3750 mm Hg), in another embodiment about 86 kPa to about 266 kPa (about 650 mm Hg to about 2000 mm Hg), in another embodiment about 91 kPa to about 200 kPa (about 690 mm Hg to about 1500 mm Hg), and in yet another embodiment about 95 kPa to about 133 kPa (about 715 mm Hg to about 1000 mm Hg); and at a temperature including about 15° C. to about 70° C., and in another embodiment about 25° C. to about 70° C.

The process optionally includes mixing the other optional performance additives as described above. The optional performance additives may be added sequentially, separately or as a concentrate.

### INDUSTRIAL APPLICATION

The method and composition disclosed herein can be useful for the reduction and/or inhibition of asphaltene deposit formation and/or flocculation in a subterranean oil reservoir, oil pipe line or storage vessel or other relevant equipment a hydrocarbon fluid e.g. a crude oil may come in contact with. The method and composition can also be useful in the reduction and/or inhibition of deposit formation and settling in industrial and marine hydrocarbon fuel systems, including where fuel stream mixing may occur and give rise to asphaltenic destabilization, agglomeration and settling or deposition. The method and composition can also be useful in the inhibition of deposition of asphaltenic species at surfaces in refinery and petrochemical processes.

The quaternary ammonium salts described above may be added to the hydrocarbon fluid, for example, in an oil reservoir, pipe line, or storage vessel or other relevant equipment, at levels of about 1 ppm to 30 wt % relative to the amount of hydrocarbon fluid present, in another embodiment 5 ppm to 10 wt %, in another embodiment 20 ppm to 3 wt % and in another embodiment 40 ppm to 1 wt %. For example the dispersant can be present in a hydrocarbon fluid from about 60 ppm to about 500 ppm or about 80 ppm to about 350 ppm relative to the amount of the hydrocarbon fluid present.

As used herein, the term “condensation product” is intended to encompass esters, amides, imides and other such materials that may be prepared by a condensation reaction of an acid or a reactive equivalent of an acid (e.g., an acid halide, anhydride, or ester) with an alcohol or amine, irrespective of whether a condensation reaction is actually performed to lead directly to the product. Thus, for example, a particular ester may be prepared by a transesterification reaction rather than directly by a condensation reaction. The resulting product is still considered a condensation product.

The amount of each chemical component described is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

As used herein, the term “hydrocarbyl substituent” or “hydrocarbyl group” is used in its ordinary sense, which is well-known to those skilled in the art. Specifically, it refers to a group having a carbon atom directly attached to the remainder of the molecule and having predominantly hydrocarbon character. Examples of hydrocarbyl groups include:

hydrocarbon substituents, that is, aliphatic (e.g., alkyl or alkenyl), alicyclic (e.g., cyclo alkyl, cycloalkenyl) substituents, and aromatic-, aliphatic-, and alicyclic-substituted aromatic substituents, as well as cyclic substituents wherein the ring is completed through another portion of the molecule (e.g., two substituents together form a ring);

substituted hydrocarbon substituents, that is, substituents containing non-hydrocarbon groups which, in the context of this disclosure, do not alter the predominantly hydrocarbon nature of the substituent (e.g., halo (especially chloro and fluoro), hydroxy, alkoxy, mercapto, alkylmercapto, nitro, nitroso, and sulfoxy);

hetero substituents, that is, substituents which, while having a predominantly hydrocarbon character, in the context of this disclosure, contain other than carbon in a ring or chain otherwise composed of carbon atoms and encompass substituents as pyridyl, furyl, thienyl and imidazolyl. Heteroatoms include sulfur, oxygen, and nitrogen. In general, no more than two, or no more than one, non-hydrocarbon substituent will be present for every ten carbon atoms in the hydrocarbyl group; alternatively, there may be no non-hydrocarbon substituents in the hydrocarbyl group.

It is known that some of the materials described above may interact in the final formulation, so that the components of the final formulation may be different from those that are initially added. For instance, metal ions (of, e.g., a detergent) can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the composition disclosed herein encompasses the composition prepared by admixing the components described above.

The technology herein can be useful for asphaltene control, which may be better understood with reference to the following examples.

The following examples provide an illustration of various aspects of the invention. These examples are non exhaustive and are not intended to limit the scope of the invention.

### Examples

### Preparative Sample 1

### 1000 Mn PIB Succinimide Propylene Oxide Quat-74% Active

A 1000 Mn polyisobutylene succinic anhydride, made via the alder-ene reaction of a 1000 Mn high vinylidene polyisobutylene with maleic anhydride having a theoretical acid number of 120 mg KOH/g (100% actives, 100 parts by weight “pbw”), was heated to 80° C. and charged to a jacketed reaction vessel fitted with a stirrer, condenser, feed pump attached to a subline addition pipe, nitrogen line and mantle/thermocouple/temperature controller system. The reaction vessel is heated to 100° C., where dimethylaminopropylamine (DMAPA) (10.90 pbw) is charged to the reaction maintaining the batch temperature below 120° C. The reaction mixture was then heated to 150° C. and held for 3 hours. The resulting product, a non-quaternized succinimide detergent, was cooled and collected. The material was then heated to 75° C. and charged to the jacketed reaction vessel and 2-ethyl hexanol (40.86 pbw), water (1 pbw) and acetic acid (5.91 pbw) were charged to the vessel and held for 3 hours. Propylene oxide (8.14 pbw) was then charged via a subsurface sparge ring, and the reaction held at 75° C. for 6 hours. The resulting product was a mixture containing about 74 wt % quaternized succinimide.

### Preparative Sample 2

### 1550 Mn PIB Succinimide Propylene Oxide Quat-69% Active

A 1550 Mn polyisobutylene succinic anhydride, made via the alder-ene reaction of a 1550 Mn polyisobutylene with maleic anhydride having a theoretical acid number of 87 mg KOH/g (900.6 g, CO:N 1:1), was charged to a 2 L round bottom flange flask fitted with a stirrer, Dean-Stark trap with water cooled condenser, subsurface N₂ inlet and mantle/thermocouple/temperature controller system. The reaction vessel was heated to 95° C., upon which DMAPA (70.5 g, CO:N 1:1) was charged subsurface over 30 minutes. Upon completion of addition, the reaction was heated to 150° C., and held for 3 hours 50 minutes. The resulting product, a polyisobutylene succinimide was cooled and 947.5 g collected without filtering.

The polyisobutylene succinimide (500.0 g), 2-ethylhexanol (250.7 g) and water (5.1 g, 1 wt % with respect to the polyisobutylene succinimide) were charged into a 1 L round bottom flange flask fitted with a stirrer, water cooled condenser, N₂ inlet, and mantle/thermocouple/temperature controller system. The reaction vessel was heated to 75° C. with agitation (180 rpm). Once at temperature, the reaction was left to mix for 15 minutes prior to acetic acid (21.4 g) being charged to the flask. Propylene oxide (40.79 g) was then charged subsurface; via syringe pump over 195 minutes (rate 13.9 ml/hr). 10 minutes into the addition the stir rate was increased to 280 rpm to ensure incorporation of the propylene oxide. Upon completion of the addition, the reaction was held at 75° C. for 3 hours. The resulting product was cooled and 816.8 g collected without filtering, giving a mixture having about 69 wt % quaternized succinimide.

### Preparative Sample 3

### 2300 Mn PIB Succinimide Propylene Oxide Quat-57% Active

A 2300 Mn polyisobutylene succinic anhydride, made via the alder-ene reaction of a 2300 Mn polyisobutylene with maleic anhydride having a theoretical acid number of 43 mg KOH/g (1000.4 g, CO:N 1:1, 33% oil), was charged to a 2 L round bottom flange flask fitted with a stirrer, Dean-Stark trap with water cooled condenser, subsurface N₂ inlet and mantle/thermocouple/temperature controller system. The reaction vessel was heated to 95° C., upon which DMAPA (37.5 g, CO:N 1:1) was charged subsurface over 17 minutes. Upon completion of addition, the reaction was heated to 150° C., and held for 4 hours. The resulting product, a polyisobutylene succinimide was cooled and 1023.0 g collected without filtering.

The polyisobutylene succinimide (600.7 g, 68% active), 2-ethylhexanol (138.7 g) and water (4.2 g, 1 wt % with respect to the polyisobutylene succinimide) were charged into a 1 L round bottom flange flask fitted with a stirrer, water cooled condenser, N₂ inlet, and mantle/thermocouple/temperature controller system. The reaction vessel was heated to 75° C. with agitation (180 rpm). Once at temperature, the reaction was left to mix for 15 minutes prior to acetic acid (12.78 g) being charged to the flask. Propylene oxide (10.59 g) was then charged subsurface; via syringe pump over 178 minutes (rate 4.0 ml/hr). Upon completion of the addition, the reaction was held at 75° C. for 3 hours. The resulting product was cooled and 751.1 g collected without filtering. Analytics indicated incomplete conversion. 578.7 g of material was reworked by heating to 75° C. in the 1 L round bottom flask. Once at temperature, water (1.9 g) and acetic acid (2.3 g) were added to the flask. The reaction was mixed for 15 minutes, prior to propylene oxide (14.17 g) being charged subsurface via syringe over 122 minutes (rate 7.5 ml/h). During the addition, the stir rate was increased 285 rpm, to ensure propylene oxide incorporation. Once the addition was complete, the reaction was held for 2 hours 45 minutes, prior to cooling. The resultant material was discharged without filtering to give 593.1 g of a mixture having about 57 wt % quaternized succinimide.

### Preparative Sample 4

### 1000 Mn PIB Succinimide Dimethyl Sulfate Quat-50% Active

A 1000 Mn polyisobutylene succinic anhydride, made via the alder-ene reaction of a 1000 Mn high vinylidene polyisobutylene with maleic anhydride having a theoretical acid number of 120 mg KOH/g (100% actives, 100 parts by weight “pbw”), was heated to 80° C. and charged to a jacketed reaction vessel fitted with a stirrer, condenser, feed pump attached to a subline addition pipe, nitrogen line and mantle/thermocouple/temperature controller system. The reaction vessel is heated to 100° C., where dimethylaminopropylamine (DMAPA) (10.90 pbw) is charged to the reaction maintaining the batch temperature below 120° C. The reaction mixture was then heated to 150° C. and held for 3 hours. The resulting product, a non-quaternized succinimide detergent, was diluted in an aliphatic petroleum naptha solvent to about 50.4 wt % actives. The material was then cooled to 40° C. and dimethyl sulfate (DMS) (0.9 eq) was charged. The reaction exothermed by 25° C., and was held at 70° C. for 2 hours after the addition. The resulting product was a mixture containing about 50 wt % quaternized succinimide.

### Comparative Samples 1-3

Comparative samples 1-3 are commercial asphaltene inhibitors, 1) a Polyolefin ester under the trade name Lubrizol® 5948, available from Lubrizol, 2) a Polyolefin amide alkeneamine under the trade name Lubrizol® 5938C, available from Lubrizol, and 3) a Novolak, under the trade name FloZol® 2252H, available from Lubrizol.

### Comparative Sample 4

### 1000 Mn PIB Succinimide

A 1000 Mn polyisobutylene succinic anhydride, made via the alder-ene reaction of a 1000 Mn high vinylidene polyisobutylene with maleic anhydride having a theoretical acid number of 120 mg KOH/g (100% actives, 100 parts by weight “pbw”), was heated to 80° C. and charged to a jacketed reaction vessel fitted with a stirrer, condenser, feed pump attached to a subline addition pipe, nitrogen line and mantle/thermocouple/temperature controller system. The reaction vessel is heated to 100° C., where dimethylaminopropylamine (DMAPA) (10.90 pbw) is charged to the reaction maintaining the batch temperature below 120° C. The reaction mixture was then heated to 150° C. and held for 3 hours. The resulting product, a non-quaternized succinimide detergent, was cooled and collected.

### Example 1

### Optical Settling Rate Measurement Test

The light turbidity test is used to determine the rate of flocculation and/or settling of an asphaltene dispersion, i.e. the point where the asphaltene is no longer stabilized in oil, and its rate of settling following the introduction into the test oil a sample asphaltene dispersant. The test employs filling a measurement cell of a Turbiscan® MA 2000 liquid dispersion optical characterization apparatus with a test oil and flocculant (e.g., hexane, heptane), and scanning 70 mm deep into the test oil in order to periodically measure the progression of the asphaltene settling front. The change in light transmittance (relative to time zero) relayed by the scanning apparatus can be expressed as a percentage change in the average light transmission (relative to time zero) through the sample over the 70 mm scanned depth, from a light source having a wavelength of 850 nm. The stability of the asphaltenic dispersion in the oil is determined by measuring the average percentage change in light transmitted on the addition of the sample asphaltene dispersant at regular intervals over a specified test period.

In order to compare different oils and asphaltene dispersants with different responses in the percent change in light transmission, the percent change in light transmission data can be restated in terms of percent asphaltene dispersion. The percent asphaltene dispersion can be calculated by the following equation:

% Asphaltene Dispersion=[(TC_{blank}−TC_{chemical})/TC_{blank}]×100

where,

TC_{blank} is the change in light transmission for an untreated oil

TC_{chemical} is the change in light transmission for the treated oil

Generally samples with a higher % Asphaltene Dispersion have more stable asphaltene dispersions than samples with lower % Asphaltene Dispersion.

The preparative and comparative samples were tested in four different crude oils at two concentrations of 50 and 200 ppm. The four different crude oils each had a different level of asphalt content by weight, and therefore a different baseline % light transmission. Generally, oils with lower 4104-01% change in light transmission over the course of the test are considered more stable. Oil 1 had an asphalt content of about 0.46% and a % light transmission of 29.4, Oil 2 had an asphalt content of about 1.70% and a % light transmission of 41.3, Oil 3 had an asphalt content of about 2.44% and a % light transmission of 38.3, and Oil 4 had an asphalt content of about 6.77% and a % light transmission of 45.3.

The calculated % Asphaltene Dispersion for each Sample tested is shown in Table 1.

TABLE 1

| | Oil 1 | | Oil 2 | | Oil 3 | | Oil 4 | |
|---|---|---|---|---|---|---|---|---|
| Sample treat | 50 | 200 | 50 | 200 | 50 | 200 | 50 | 200 |
| rate (ppm) | | | | | | | | |
| Crude Injection | 500 | 500 | 400 | 400 | 200 | 200 | 100 | 100 |
| Amount (μL) | | | | | | | | |
| Measurement | 30 | 30 | 20 | 20 | 20 | 20 | 20 | 20 |
| Time (min) | | | | | | | | |
| Preparative | 79.7 | 95.6 | 95.2 | 100.0 | 12.9 | 100.0 | 20.9 | 99.4 |
| Sample 1 | | | | | | | | |
| Preparative | 26.5 | 96.7 | — | — | — | — | 3.9 | 40.0 |
| Sample 2 | | | | | | | | |
| Preparative | 2.4 | 80.8 | — | — | — | — | 0.3 | 42.3 |
| Sample 3 | | | | | | | | |
| Preparative | 14.3 | 90.7 | — | — | — | — | 9.0 | 49.7 |
| Sample 4 | | | | | | | | |
| Comparative | 96.1 | 97.0 | 100.0 | 100.0 | 83.8 | 100.0 | 8.9 | 86.6 |
| Sample 1 | | | | | | | | |
| Comparative | 0.0 | 94.4 | 100.0 | 100.0 | 56.7 | 100.0 | 6.1 | 50.1 |
| Sample 2 | | | | | | | | |
| Comparative | 0.0 | 94.0 | 0.0 | 2.6 | 4.5 | 14.8 | 3.7 | 40.4 |
| Sample 3 | | | | | | | | |
| Comparative | 0.0 | 7.4 | 0.0 | 0.0 | 6.1 | 16.8 | 1.6 | 39.9 |
| Sample 4 | | | | | | | | |

Overall the analysis indicates that the method and composition disclosed herein can provide a reduction and/or inhibition of asphaltene flocculation and/or deposit formation in a subterranean oil reservoir, oil pipe line or storage vessel or other relevant equipment a hydrocarbon fluid may come in contact with.

Each of the documents referred to above is incorporated herein by reference, including any prior applications, whether or not specifically listed above, from which priority is claimed. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

What is claimed is:

1. A method of asphaltene control in a hydrocarbon fluid, comprising employing a quaternary ammonium salt comprising the reaction product of:
a. the reaction product of a hydrocarbyl substituted acylating agent and a compound having an oxygen or nitrogen atom capable of condensing with said hydrocarbyl substituted acylating agent and further having a tertiary amino group; and
b. a quaternizing agent suitable for converting the tertiary amino group to a quaternary nitrogen.

2. The method of claim 1, wherein the quaternizing agent is selected from the group consisting of dialkyl sulfates; alkyl halides; benzyl halides; haloacetic acids/salts; hydrocarbyl substituted carbonates; hydrocarbyl substituted oxalate esters; hydrocarbyl epoxides optionally in combination with an acid; and mixtures thereof.

3. The method of any previous claim, wherein the hydrocarbyl substituted acylating agent is a polyisobutylene succinic acid or anhydride.

4. The method of claim 3, wherein the polyisobutylene of the polyisobutylene succinic acid or anhydride has a number average molecular weight of from between about 150 to about 5000.

5. The method of any of claim 1 or 2, wherein the hydrocarbyl substituted acylating agent is a polyhydroxy carboxylic acid.

6. The method of claim 5, wherein the polyhydroxy carboxylic acid is polyhydroxy stearic acid.

7. The method of any previous claim wherein the compound having an oxygen or nitrogen atom capable of condensing with said hydrocarbyl substituted acylating agent and further having a tertiary amino group is N,N-dimethyl-1,3-diaminopropane.

8. The method of any previous claim, wherein the hydrocarbon fluid has an asphaltene content of at least 0.01 wt %.

9. The method of any previous claim, wherein the hydrocarbon fluid has an asphaltene content of up to 90 wt % based on the total weight of the hydrocarbon fluid.

10. The method of any previous claim, wherein the hydrocarbon fluid is an oil field product, a refinery or petrochemical process stream, a heavy distillate or residual fuel.

11. A composition comprising:
a. a crude oil; and
b. a quaternary ammonium salt, comprising the reaction product of:
i. the reaction product of a hydrocarbyl substituted acylating agent and a compound having an oxygen or nitrogen atom capable of condensing with said hydrocarbyl substituted acylating agent and further having a tertiary amino group; and
ii. a quaternizing agent suitable for converting the tertiary amino group to a quaternary nitrogen.

12. (canceled)

13. (canceled)

14. (canceled)
